(19) United States
(12) Patent Application Publication
(10) Pub. No.: US 2013/0088009 A1
(43) Pub. Date: Apr. 11, 2013

(54) Method to Prevent Over Torque of Yaw Drive Components in a Wind Turbine

(71) Applicants: Kevin Cousineau, Ridgecrest, CA (US); Ehren Van Schmus, Santa Clara, CA (US); Marty Gardner, Carpinteria, CA (US)

(72) Inventors: Kevin Cousineau, Ridgecrest, CA (US); Ehren Van Schmus, Santa Clara, CA (US); Marty Gardner, Carpinteria, CA (US)

(73) Assignee: Clipper Windpower, LLC, Carpinteria, CA (US)

(21) Appl. No.: 13/487,726

(22) Filed: Jun. 4, 2012

Related U.S. Application Data
(60) Provisional application No. 61/546,005, filed on Oct. 11, 2011.

(51) Int. Cl. H02P 9/04

(52) U.S. Cl. 290/44

(57) ABSTRACT

A method for preventing over torque and failure of yaw system components in a wind turbine is disclosed. The method may include providing a yaw system having a yaw drive including a drive motor for facing a nacelle positioned on the yaw system in a preferred wind direction. The method may also include preventing operation of the drive motor beyond a normal operating region on a torque-speed curve of the drive motor to avoid torques that may damage the yaw system components.

### CROSS-REFERENCE TO RELATED APPLICATION

This is a non-provisional US patent application, which claims priority under 35 USC §119(e) to U.S. Provisional Patent Application Ser. No. 61/546,005 filed on Oct. 11, 2011.

### FIELD OF THE DISCLOSURE

The present disclosure generally relates to wind turbines and, more particularly, relates to preventing failure of yaw drive components in wind turbines due to over torque.

### BACKGROUND OF THE DISCLOSURE

A horizontal axis utility-scale wind turbine typically includes a set of two or three large rotor blades mounted to a hub. The rotor blades and the hub together are referred to as the rotor. The rotor blades, through aerodynamically interaction with the incoming wind, generate lift, which is then translated into a driving torque by the rotor. The rotor is attached to and drives a main shaft, which in turn is operatively connected via a drive train to a generator or a set of generators that produce electrical power. The main shaft, the drive train and the generator(s) are all situated within a nacelle.

The nacelle is mounted on top of a yaw bearing, which in turn is mounted on top of a tower. A yaw drive rotates the nacelle (via the yaw bearing) relative to the tower to point the rotor of the wind turbine directly into the wind (or other preferred orientation) for maximum wind power capture and energy production. The yaw drive typically includes an electrical motor coupled to a speed reducing, torque increasing gearbox that drives a pinion gear. This pinion gear, in turn, engages a ring gear integrally connected with the wind turbine's yaw bearing assembly.

Yawing the wind turbine can sometimes require a large amount of torque. With rotor blade lengths or rotor diameters of seventy five to one hundred fifty meters (75 to 150 meters), the airfoils of the rotor blades can generate tremendous amounts of torque even during modest winds. The yaw systems must counteract much of these forces especially during off axis inflow, in order to align the wind turbine's nacelle with the incoming wind direction. The yaw system's job is to generate sufficient torque between the nacelle and the tower to yaw the nacelle relative to the tower. The torque requirements can be very high. Even though wind turbine designers try to design yaw drive components to withstand the demanding conditions of the wind turbine, many manufacturers' wind turbines have experienced failures in yaw drives and particularly, pinions gears of yaw drives. The reason for these failures is not always well understood.

Accordingly, it would be beneficial if a more complete understanding of the cause of failures of yaw drive components were developed. It would be additionally beneficial if such an understanding would lead to an effective mechanism for yawing the wind turbine while preventing damage of yaw drive components.

### SUMMARY OF THE DISCLOSURE

In accordance with at least some embodiments of the present disclosure, a method for preventing over torque of yaw system components in a wind turbine is disclosed. The method may include providing a yaw system having a yaw drive and a drive motor for facing a nacelle positioned on the yaw system in a preferred wind direction and preventing operation of the drive motor beyond a normal operating region on a torque-speed graph of the drive motor.

In accordance with some other aspects of the present disclosure, a method for preventing failure of yaw system components in a wind turbine is disclosed. The method may include providing a yaw system having a yaw drive and a drive motor for facing a nacelle positioned on the yaw system in a preferred wind direction, the yaw system further having yaw brakes for controlling rotation of the nacelle, determining a slippage in the yaw brakes by at least one of (a) measuring a change in yaw angle of the wind turbine; and (b) measuring an instantaneous speed of the drive motor and refraining from turning the drive motor on if the slippage in the yaw brakes is determined.

In accordance with yet other aspects of the present disclosure, a method for preventing a drive motor from supplying excessive torque in a yaw system of a wind turbine is disclosed. The method may include providing a yaw system having a yaw drive and a drive motor for facing a nacelle positioned on the yaw system in a preferred wind direction, the yaw system further having yaw brakes for controlling rotation of the nacelle and preventing operation of the drive motor in at least one of a first region and a second region of a torque-speed curve for the drive motor, the first region including operation of the drive motor at hypersynchronous speeds above a maximum normal rated speed for the drive motor and the second region including operation of the drive motor at speeds in a reverse direction, each of the first region and the second region supplying excessive torque above a maximum normal rated torque value for the drive motor.

### BRIEF DESCRIPTION OF THE DRAWINGS

For a more complete understanding of the disclosed methods and apparatuses, reference should be made to the embodiments illustrated in greater detail on the accompanying drawings, wherein:

FIG. 1 is a schematic illustration of a wind turbine, in accordance with at least some embodiments of the present disclosure;

FIG. 2 is an exemplary yaw system that may be employed within the wind turbine of FIG. 1; and

FIG. 3 is an exemplary torque-speed graph of an exemplary drive motor employed within the yaw system of FIG. 2, in accordance with at least some embodiments of the present disclosure.

While the following detailed description has been given and will be provided with respect to certain specific embodiments, it is to be understood that the scope of the disclosure should not be limited to such embodiments, but that the same are provided simply for enablement and best mode purposes. The breadth and spirit of the present disclosure is broader than the embodiments specifically disclosed and encompassed within the claims eventually appended hereto.

### DETAILED DESCRIPTION OF THE DISCLOSURE

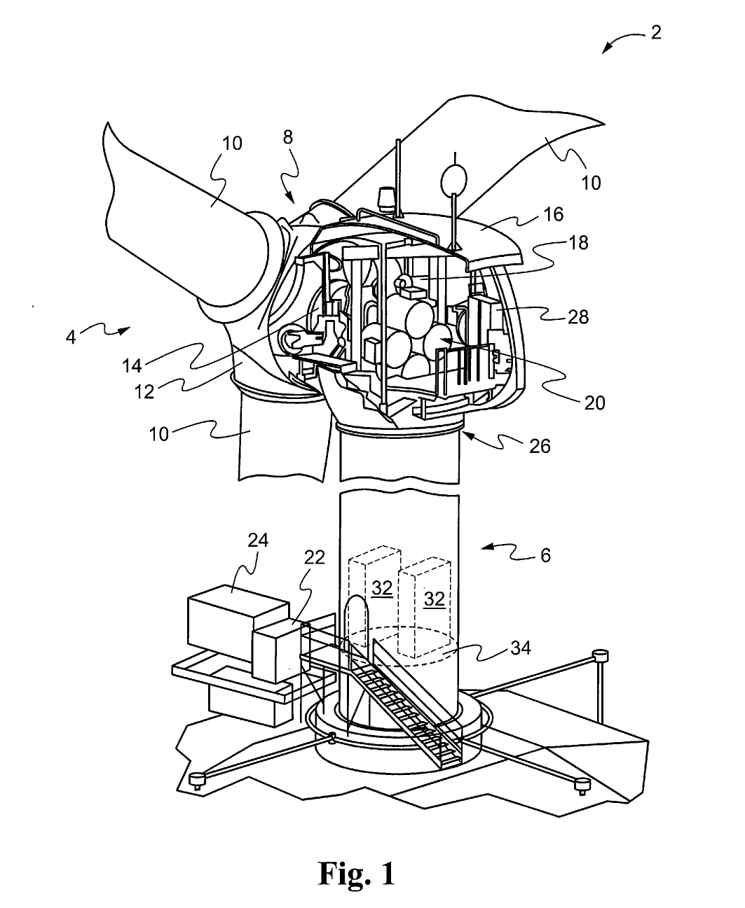

Referring to FIG. 1, an exemplary wind turbine 2 is shown, in accordance with at least some embodiments of the present disclosure. While all the components of the wind turbine have not been shown and/or described, a typical wind turbine may include an up tower section 4 and a down tower section 6. The up tower section 4 may include a rotor 8, which in turn may include a plurality of blades 10 connected to a hub 12. The blades 10 may rotate with wind energy and the rotor 8 may transfer that energy to a main shaft 14 situated within a nacelle 16. The nacelle 16 may additionally include a drive train 18, which may connect the main shaft 14 on one end to one or more generators 20 on the other end. The generators 20 may generate power, which may be transmitted from the up tower section 4 through the down tower section 6 to a power distribution panel (PDP) 22 and a pad mount transformer (PMT) 24 for transmission to a grid (not shown). The PDP 22 and the PMT 24, which are typically positioned outside (e.g., in the vicinity) of the wind turbine 2, may also provide electrical power from the grid to the wind turbine for powering several auxiliary components thereof. In at least some embodiments, the PDP and/or the PMT may be positioned within the wind turbine as well.

In addition to the components of the wind turbine 2 described above, the up tower section 4 of the wind turbine may include several auxiliary components, such as, a yaw system 26 (described in greater detail below) on which the nacelle 16 may be positioned to pivot and orient the wind turbine in a direction of the wind current or another preferred wind direction (e.g., for correcting the error between the nacelle direction and the incoming wind direction or simply forcing the nacelle into a new position as required by the controls for other purposes), a pitch control system (not visible) situated within the hub 12 for controlling the pitch (e.g., angle of the blades with respect to the wind direction) of the blades 10, a hydraulic power system (not visible) to provide hydraulic power to various components such as brakes of the wind turbine, a cooling system (also not visible), and the like. Notwithstanding the components of the wind turbine 2 described above, it will be understood that the wind turbine 2 may include several other components that are contemplated and considered within the scope of the present disclosure. Furthermore, a turbine control unit (TCU) 28 may be situated within the nacelle 16 for controlling the various components of the wind turbine 2.

With respect to the down tower section 6 of the wind turbine 2, among other components, the down tower section may include one or more generator control units (GCUs) 32 and a down tower junction box (DJB) 34 for routing and distributing power between the wind turbine and the grid. Several other components, such as, ladders, access doors, etc., that may be present within the down tower section 6 of the wind turbine 2 are contemplated and considered within the scope of the present disclosure.

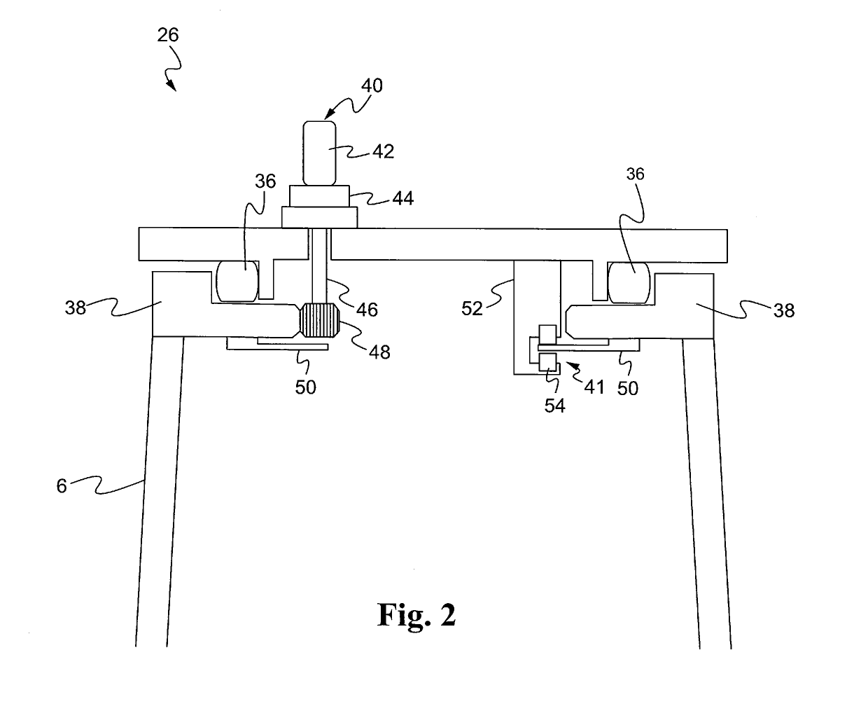

Referring now to FIG. 2, an exemplary yaw system 26 is shown, in accordance with at least some embodiments of the present disclosure. The yaw system 26 may be employed in any of a variety of horizontal axis wind turbine machines and, as described above, it may be employed to orient the wind turbine 2 into a preferred wind direction for maximum wind capture and energy production. Typically, the yaw system 26 may be positioned between the nacelle 16 and the down tower section 6 of the wind turbine 2 and, as shown, it may include a yaw bearing 36 and a ring gear (or slew gear) 38 mounted on top of the down tower section 6, a yaw drive 40 for providing a means for changing the orientation of the nacelle 16, one or more yaw brakes 41 for restricting motion of the nacelle and a control system (not shown) for issuing commands to control the various components of the yaw system.

With respect to the yaw bearing 36 and the ring gear 38, they may serve as a rotatable connection between the down tower section 6 and the nacelle 16 of the wind turbine 2. The yaw bearing 36 may be any of a variety of commonly employed bearings in wind turbines, such as, a ball bearing or cylindrical roller type bearing, or the like. The yaw bearing 36 may be designed to withstand high loads, apart from the weights of the nacelle 16 and the rotor 8. The yaw bearing 36 in conjunction with the ring gear 38 and the yaw drive 40 may cause the nacelle 16 to smoothly turn and face directly in the wind direction or other preferred direction. The yaw drive 40 may include a powerful alternating current (AC) asynchronous induction motor or drive motor 42 and a large gearbox 44 (e.g., a planetary gearbox) for increasing the torque of the drive motor. The drive motor 42 and the gearbox 44 may be mounted on a shaft 46. The yaw drive 40 may also include a pinion 48 for transmitting torque from the drive motor 42 to engage the gear rim 38 to facilitate turning of the nacelle 16. Instead of a single yaw drive 40, the yaw system 26 may include several similar yaw drives. For example, in some current wind turbines, up to eight yaw drives are used and spaced around the ring gear.

Yaw brakes 41 may be utilized for locking the yaw system 26 against rotation to prevent the nacelle 16 from rotating (e.g., after the nacelle 16 has been oriented in the proper wind direction). As shown, the yaw brakes 41 may include a brake disc 50 and one or more brake calipers 52 (only one of which is visible), brake pistons 54 (again, only one of which is visible) and brake pads (not shown). In addition to locking the yaw brakes 41 to prevent yaw rotation of the nacelle 16, the yaw brakes 41 may also be employed during yawing to apply a small counter-torque against the yaw drive 40 (using partial pressure against the brake pistons 54) to eliminate backlash between the ring gear 38 and the pinion 48 and to smooth the accelerations of the yaw motion.

Notwithstanding the components of the yaw system 26 described above, it will be understood that the yaw system may employ several other components, such as various speed or position sensors, a wind vane to sense wind direction, etc.

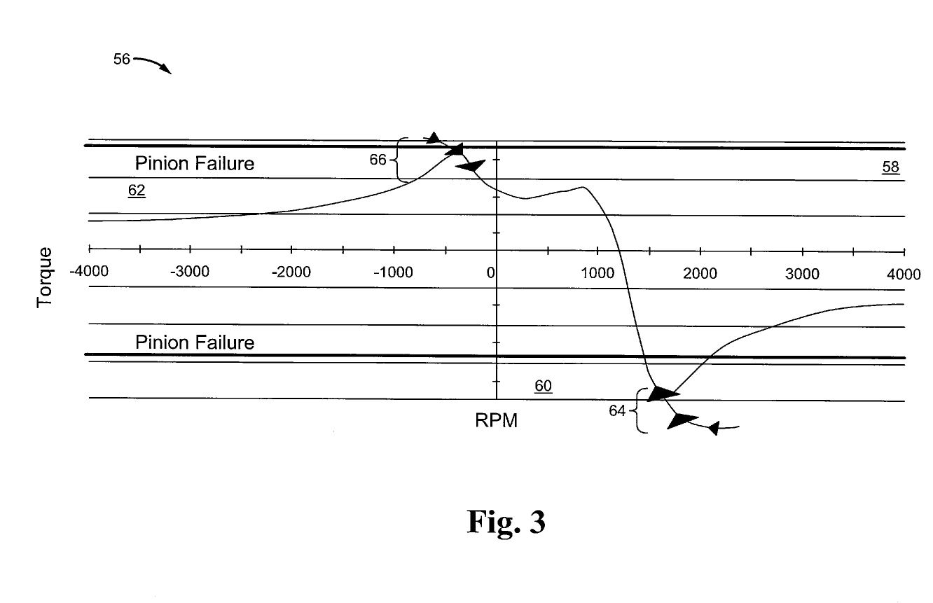

Turning now to FIG. 3, an exemplary torque-speed graph 56 for the drive motor 42 only is shown, in accordance with at least some embodiments of the present disclosure. As shown, the graph 56 plots torque on the Y-axis against the speed of the drive motor 42 in revolutions per minute (RPM) on the X-axis. It will be understood that the curve of the torque-speed graph 56 as well as the RPM values shown thereon are merely exemplary and will vary in other embodiments depending upon the design of the drive motor 42. However, it will also be understood that the description of the torque-speed graph 56 below and the operation of the drive motor 42 in various regions of the graph will be applicable (with somewhat minor variations in region boundaries) to most (possibly all) drive motors that are commonly employed in wind turbine yaw systems.

While the drive motor 42 is typically designed to operate (e.g., turn) at a specific synchronous speed (typically between around 1-1300 RPMs), referred to herein as normal rated speed, and supply a set amount of torque, the inventors of the present disclosure have recognized that in the wind turbine 2, the drive motor may be operated at speeds well above or below its normal rated speed and also at speeds in a reverse drive direction. Operation of the drive motor 42 above or below its normal rated speed, as well as in the reverse directions may cause the drive motor to create excessive torque beyond its normal rated maximum torque value in the typical region of operation. The amount of excessive torque supplied by the drive motor 42 in the alternate region(s) of operation may depend upon the yaw torque created by the wind (due to high aerodynamic loads) on the rotor 8. It is this excessive torque that may cause the components of the yaw system 26 and, particularly, the yaw drive 40 and/or the pinion 48 to be damaged.

The operation of the drive motor 42 at above or below its normal rated speed and also in the reverse direction may be understood by referring to the graph 56 of FIG. 3. Specifically, synchronous motors, such as, the drive motor 42 are typically designed to operate in an upper right quadrant 58 of the graph 56 where both the torque on the Y-axis and the speed on the X-axis are positive, i.e., in the same direction. The upper right quadrant 58 may be referred to as a normal operating region of the drive motor 42 and in this region the drive motor 42 is the driving machine while the wind turbine 2 is the driven machine. The operation of the drive motor 42 in the normal operating region is generally well understood.

However, under certain wind conditions, the drive motor 42 may operate in a bottom right quadrant or first region 60 (positive X and negative Y), where the drive motor may operate at speeds much greater than the maximum normal rated speed (of about 1300 RPM) of the drive motor and generate torque in excess of the maximum rated torque from the typical region of operation. In yet other wind conditions, the drive motor 42 may also operate in an upper left quadrant or second region 62 (positive Y and negative X), where the drive motor 42 may operate in a reverse direction or close to stall and also supply excessive torque. Both the first and the second regions 60 and 62, respectively, which are conventionally not well understood, are described in further detail below. The inventors have recognized that when the drive motor 42 becomes the driven machine in the first region 60 and/or the second region 62, excessive resistive torque may be supplied by the drive motor and operate beyond allowable limits, which may eventually lead to failure of yaw drive components, and particularly, failure of the yaw drive 40 and/or the pinion 48.

Specifically, with respect to the first region 60, the drive motor 42 may operate in this region when, for example, the wind pushes the rotor 8 to rotate in the same direction as the yaw drive 40. In such an event, the drive motor 42 may operate at a higher RPM than it normally would, or a hyper synchronous speed, with the help of the wind and a resistive torque (i.e., negative torque) which is greater than the maximum rated normal torque value (in the typical region of operation 58) may be generated, as indicated on the graph 56. In the second region 62, the wind may push the rotor 8 to rotate in the opposite direction as the yaw drive 40, and the drive motor 42 may operate at a speed lower than its normal synchronous speed, or may even operate in a reverse speed direction or come to near or complete stall. When the drive motor 42 operates at speeds in the reverse direction, excessive torque greater than the maximum rated normal torque value (in the typical region of operation 58) may also be generated as indicated on the graph 56.

Plot portions 64 and 66 of the torque-speed curve in the graph 56 illustrate possible deviations that may occur during cut-in operation of the drive motor 42 under certain conditions. The plot portion 64 represents the potential torque-speed behavior of drive motor 42 when it is turned on while the drive motor is already rotating or being driven above synchronous speed. The plot portion 66 represents the potential torque-speed behavior of drive motor 42 when it is turned on while the drive motor is already being driven in a reverse direction. These plot portions 64 and 66 represent two possible transient cut-in responses, and actual cut-in response of the resistive torque supplied by the drive motor 42 might vary from these examples, nevertheless these examples help illustrate that transient conditions might produce forces even greater than during steady-state operation. Whether considering steady state operation of the drive motor 42 in the regions 60 and 62, or the transient cut-in operation in these regions, it can be seen that either may be capable of generating motor torque that is in excess to the rated torque of the typical region of operation in the region 58. It is believed that this excessive torque in the regions 60 and 62 is the source of high torques that damage the yaw drive 40 and in particular the pinion 48.

In addition to recognizing the reason for the failure of the components, the inventors of the present disclosure have also proposed a solution for preventing such excessive torque values to be supplied by the drive motor.

The proposed solution provides a mechanism for preventing the drive motor 42 from operating in either the first region 60 or in the second region 62, and particularly from cutting-in in these regions of operation resulting in torques illustrated along the plot portions 64 and 66. While the operation of the drive motor 42 up to a certain threshold in both the first region 60 and the second region 62 may be tolerated, operation of the drive motor beyond that threshold may cause the excessive supplied torque to damage the yaw drive 40. During yaw action when the drive motor 42 is operated beyond the threshold mentioned above in the first region 60 or the second region 62, either in the direction of drive or against it, the operation of the drive motor 42 should be ceased and the yaw brakes applied until such time as the yawing can be safely resumed or completed. Thus, in at least some embodiments, a determination of whether the drive motor 42 is rotating faster than threshold speeds established in regions 60 and 62 will help determine whether the operation of the drive motor 42 should be stopped to avoid damage.

Whether the drive motor 42 is rotating faster than threshold speeds during operation can be determined through the use of a speed sensor mounted on the drive motor or the gearbox 44 to indicate the speed. If the indicated speed is greater than a threshold above the synchronous speed of the drive motor 42, or is negative, or exceeds some other appropriate threshold values, then the operation of the drive motor will be arrested by the control system that controls the yaw system 26, and the yaw brakes 41 applied. A position encoder (which may be present between the nacelle 16 and the down tower section 6 or the nacelle and the yaw bearing 36, or any other location) for the yaw angle of the wind turbine 2 may also be used to approximate the current speed of the drive motor 42 for control purposes by differentiating the position signal over time.

The drive motor 42 has only two basic states, on and off. When the drive motor 42 is on, the excessive torques are avoided through the speed control described above. To avoid the excessive torques when the drive motor 42 is off and is commanded to turn on, a different algorithm may be necessary, because at the instant of cut in, when the yaw brakes 41 are fully or partially released, the drive motor may be very rapidly driven to excessive hyper-synchronous or reverse speeds and cause damage before a speed monitoring algorithm could react.

Thus, in addition to the above proposed speed control, a second control is proposed which aims to detect when an excessive yaw torque is present and prevent the drive motor 42 from being turned on while such a condition persists. The excessive yaw torque could be determined by detecting whether the yaw brakes 41 are slipping while the drive motor 42 is turned off. Off-axis aerodynamic loads on the rotor 8 can be so great that the yaw torque they create can overcome the yaw brakes 41 and cause them to slip. Slipping of the yaw brakes 41 indicate that high torque is present about the yaw axis. If the yaw brakes 41 are slipping, the control may prevent the drive motor 42 from being turned on, until such time as this condition ends and yawing can safely begin. Slipping of the yaw brakes 41 can be detected, as with the previous control, by observing the signal of a speed sensor mounted on the drive motor 42 or the gearbox 44, or by differentiating a signal from a position encoder between the nacelle 16 and the down tower section 6. Any rotation of the nacelle 16 while the yaw brakes 41 are engaged and there should be no yawing action is an indication that brake slip is occurring.

The signal from a position encoder to detect the yaw position may also be integrated and used as a speed sensor in similar fashion. Specifically, slipping of the yaw brakes 41 may be detected by determining a change in a yaw angle by the position encoder of the wind turbine 2 when the yaw brakes are engaged. The yaw angle of the wind turbine 2 may be defined as the angle in degrees of the wind turbine in relation to either true or magnetic north or another fixed location on the ground plane or in relation to a fixed point on the down tower section 6 below the yaw system 26. The yaw angle may be tracked through more than three hundred and sixty degrees) (360°) in order to determine the number of complete turns that the wind turbine 2 has accumulated through shifting wind directions. A determination by the position encoder of any change or change above a certain threshold in the yaw angle may indicate brake slippage when the yaw brakes 41 are engaged. As long as the yaw brake slip condition persists, any command to start the drive motor 42 and commence yawing can be arrested or delayed until such time as it is safe to yaw, for example after a gust of wind has passed.

Other mechanisms to prevent the drive motor 42 from operating in the first or the second regions 60 and 62, respectively, may be used as well. For example, instead of turning off the drive motor 42 when the speed crosses a threshold in the first region 60, an additional brake force from the yaw brakes 41 may be applied while maintaining the drive motor's operation to slow the speed of the drive motor and reduce its resistive torque (i.e. let the resistive torque be supplied by the yaw brakes 41 rather than the yaw drive 40). Also, instead of measuring motor speeds and yaw brake slip, a torque of the drive shaft 46 may be sensed and used for control. However, this solution may not be preferred because of the added expense of a torque sensor on the drive shaft 46, whereas a speed sensor on the drive motor 42 or a position encoder for the yaw angle may be sensors that are already included on a wind turbine.

Thus, the present disclosure provides an understanding of the cause of excessive torque supplied by the drive motor and the cause of failure in yaw components, such as the pinion. The present disclosure also provides a mechanism for preventing damage to yaw components in excessive torque conditions of the yaw drive motor in a wind turbine. The mechanism may include measuring a brake slip of the yaw brakes by measuring an instantaneous speed of the yaw drive motor and determining a change in yaw angle and preventing yawing until the slip stops, and/or turning off the drive motor to control an output torque when the instantaneous speed of the drive motor varies too much from the normal rated synchronous speed.

While only certain embodiments have been set forth, alternatives and modifications will be apparent from the above description to those skilled in the art. These and other alternatives are considered equivalents and within the spirit and scope of this disclosure and the appended claims.

We claim:

1. A method for preventing over torque of yaw system components in a wind turbine, the method comprising:
providing a yaw system having a yaw drive and a drive motor for facing a nacelle positioned on the yaw system in a preferred wind direction; and
preventing operation of the drive motor beyond a normal operating region on a torque-speed graph of the drive motor.

2. The method of claim 1, wherein preventing operation of the drive motor beyond a normal operating region comprises preventing operation of the drive motor above a pre-determined threshold in a first region of the torque-speed graph.

3. The method of claim 2, wherein operation of the drive motor in the first region comprises operating the drive motor at hypersynchronous speeds above a maximum normal rated speed for the drive motor.

4. The method of claim 2, wherein operation of the drive motor in the first region comprises supplying excessive torque by the drive motor, the excessive torque being greater than a maximum normal rated torque value for the drive motor.

5. The method of claim 1, wherein preventing operation of the drive motor beyond a normal operating region comprises preventing operation of the drive motor above a pre-determined threshold in a second region of the torque-speed graph.

6. The method of claim 5, wherein operation of the drive motor in the second region comprises operating the drive motor in a reverse direction.

7. The method of claim 5, wherein operation of the drive motor in the second region comprises supplying excessive torque by the drive motor, the excessive torque being greater than a maximum normal rated torque value for the drive motor.

8. The method of claim 1, wherein preventing operation of the drive motor beyond a normal operating region comprises determining a slippage in yaw brakes of the yaw system.

9. The method of claim 8, wherein determining a slippage in the yaw brakes comprises measuring a change in a yaw angle of the wind turbine when the yaw brakes are engaged.

10. The method of claim 8, wherein determining a slippage in the yaw brakes comprises measuring an instantaneous speed of the drive motor.

11. The method of claim 8, further comprising one of turning the drive motor off and keeping the drive motor off if an instantaneous speed of the drive motor is above or below a normal rated speed of the drive motor.

12. The method of claim 8, further comprising keeping the drive motor off if slippage in the yaw brakes is determined.

13. A method for preventing failure of yaw system components in a wind turbine, the method comprising:
providing a yaw system having a yaw drive and a drive motor for facing a nacelle positioned on the yaw system in a preferred wind direction, the yaw system further having yaw brakes for controlling rotation of the nacelle;
determining a slippage in the yaw brakes by at least one of (a) measuring a change in yaw angle of the wind turbine; and (b) measuring an instantaneous speed of the drive motor; and
refraining from turning the drive motor on if the slippage in the yaw brakes is determined.

14. The method of claim 13, further comprising keeping the drive motor off until the slippage in the yaw brakes is over.

15. The method of claim 13, wherein slippage in the yaw brakes is caused by a yaw torque created by aerodynamic loads on a rotor of the wind turbine.

16. A method for preventing a drive motor from supplying excessive torque in a yaw system of a wind turbine, the method comprising:
providing a yaw system having a yaw drive and a drive motor for facing a nacelle positioned on the yaw system in a preferred wind direction, the yaw system further having yaw brakes for controlling rotation of the nacelle; and
preventing operation of the drive motor in at least one of a first region and a second region of a torque-speed curve for the drive motor, the first region including operation of the drive motor at hypersynchronous speeds above a maximum normal rated speed for the drive motor and the second region including operation of the drive motor at speeds in a reverse direction, each of the first region and the second region supplying excessive torque above a maximum normal rated torque value for the drive motor.

17. The method of claim 16, wherein preventing operation of the drive motor in at least one of the first region and the second region comprises measuring at least one of a change in yaw angle of the wind turbine and measuring an instantaneous speed of the drive motor.

18. The method of claim 16, wherein preventing operation of the drive motor in at least one of the first region and the second region comprises determining whether the yaw brakes are slipping when the drive motor is off.
